(19) United States
(12) Patent Application Publication
(10) Pub. No.: US 2007/0129863 A1
(43) Pub. Date: Jun. 7, 2007

(54) Parking guidance apparatus and method

(76) Inventors: Cheng-San Hsu, Shenkeng Township (TW); Chih-Cheng Chien, Shenkeng Township (TW)

Correspondence Address: J.C. Patents, Inc., Suite 250, 4 Venture, Irvine, CA, 92618, US

(21) Appl. No.: 11/455,994

(22) Filed: Jun. 19, 2006

(30) Foreign Application Priority Data
Dec. 6, 2005 (TW) 94142902

(51) Int. Cl. G06F 17/00

(52) U.S. Cl. 701/36; 701/1

(57) ABSTRACT

A parking guidance apparatus and method are provided. The parking guidance apparatus includes a position unit and a vehicle guidance unit. A position signal is provided by the position unit which is disposed at a position point outside of the vehicle. By sensing the power strength of the position signal and a direction thereof, the corresponding position relationship between the vehicle and the position point is calculated by the vehicle guidance unit disposed in the vehicle.

### CROSS-REFERENCE TO RELATED APPLICATION

This application claims the priority benefit of Taiwan application serial no. 94142902, filed on Dec. 6, 2005. All disclosure of the Taiwan application is incorporated herein by reference.

### BACKGROUND OF THE INVENTION

1. Field of Invention

The present invention relates to a vehicle guidance apparatus, and more particularly, to a parking guidance apparatus and method with infrared or radar wave sensing.

2. Description of Related Art

Conventional back radar or infrared sensing is mostly used in crash avoidance systems for measuring the distance of a vehicle or an object to the rear end of the car based on a signal reflection principle, and sending a warning. However, in the aspect of vehicle parking positioning, no electronic apparatus is yet widely used for parking a vehicle within a parking positioning sign of the parking space, such that the vehicle may be parked either too near to the left or to the right, or the car door may scratch the adjacent vehicle when opening the door after the vehicle is parked. A car rear view system assists a driver to watch the situation in back with the aid of miniature cameras. Multiple sets of cameras are disposed to eliminate the dead angel of the camera. However, the apparatus is exorbitant expensive, and the driver must estimate the corresponding position relationship between the vehicle and the parking space by his or her own judgment based on the images shown on the mirrors. Thus, sometimes the vehicle may hit the rear-end object as the driver tries to minimize the distance between the vehicle and the object.

Currently, the most common parking assistant uses sound as a warning for the distance between the vehicle and the barrier (such as other vehicles), but it cannot inform the driver of the accurate current position and the advancing direction when parking. In practice, when parking, such a manner of assistance can only prevent vehicles from colliding, and cannot assist the driver to park the vehicle in the right position.

### SUMMARY OF THE INVENTION

An object of the present invention is to provide a parking guidance apparatus, enabling a driver to acquire a corresponding position relationship between a vehicle and a position point outside the vehicle and assisting the driver to park the vehicle at the position point by using infrared or radar wave sensing.

Another object of the present invention is to provide a parking guidance method, enabling the driver to easily acquire the corresponding position relationship between a position point outside the vehicle and the vehicle by providing a position signal at a position point outside the vehicle.

To achieve the aforementioned and other objects, the present invention provides a parking guidance apparatus including a position unit and a vehicle unit. The position unit is disposed at a position point (e.g. the parking space) outside the vehicle, and is responsible for providing a position signal, such as an infrared or radar wave signal. The vehicle guidance unit is disposed in the vehicle for sensing power strength of the position signal and a direction thereof, and displaying a guidance message to the driver according to the power strength and direction of the position signal. The guidance message contains the corresponding position relationship between the vehicle and the position point.

In an embodiment, the vehicle guidance unit includes a signal process unit, a display unit, and at least one sensing module. The sensing module is responsible for sensing a position signal and outputting an identification signal according the intensity of the position signal and the direction. The signal process unit is coupled between the sensing module and the display unit, and outputs a guidance message according to the identification signal. The display unit is responsible for displaying the guidance message, enabling the driver to easily acquire the corresponding position relationship between the vehicle and the position point. Wherein, each sensing module has multiple sensors arranged in a circular arch and identifies the power strength and direction of the position signal by using the different arrangement and direction thereof.

In an embodiment, the vehicle guidance unit includes a guidance transmit unit for providing a guidance start signal. The position unit provides the position signal according to the guidance start signal.

From another point of view, the present invention provides a parking guidance method including first providing a position signal at a position point outside the vehicle; and in the vehicle, sensing the position signal and displaying a guidance message according to the power strength and direction of the position signal. The guidance message contains the corresponding position relationship between the vehicle and the position point.

In an embodiment, in the parking guidance method, the step of sensing the position signal further includes outputting an identification signal according to the power strength and direction of the position signal, and outputting a guidance message according to the identification signal. The way to display the guidance message includes at least one of text, graphic, indicator, and sound.

The present invention provides a position signal at the position point outside the vehicle, such that the driver in the vehicle can easily know the corresponding position relationship between the vehicle and the position point through sensing and identifying the position signal. And the present invention adopts a humanized display manner, such that the driver can easily and exactly park the vehicle at the position point.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a block diagram of a parking guidance apparatus according to an embodiment of the present invention.

FIG. 2A is a view of a single-positioning parking guidance apparatus according to another embodiment of the present invention.

FIG. 2B is a view of a single-transmitting parking guidance apparatus according to another embodiment of the present invention.

FIG. 2C is a view of a multi-transmitting parking guidance apparatus according to another embodiment of the present invention.

FIG. 3 is a view showing the relationship between the signal transmitting time and distance of the parking guidance apparatus according to an embodiment of the present invention.

FIG. 4A is schematic view showing a sensing manner of multiple sets of sensing modules according to an embodiment of the present invention.

FIG. 4B is a view showing a structure and sensing action of the sensing module according to an embodiment of the present invention.

FIG. 5 is a view of display indicators of the parking guidance apparatus according to an embodiment of the present invention.

FIG. 6 is a flow chart of a parking guidance method according to another embodiment of the present invention.

### DESCRIPTION OF EMBODIMENTS

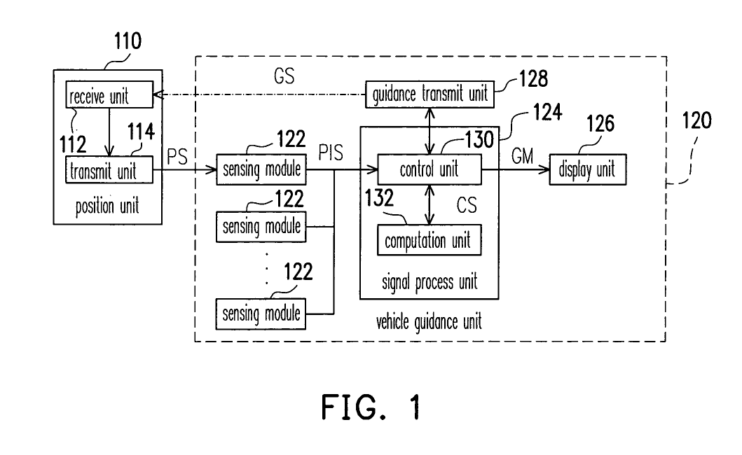

FIG. 1 is a block diagram of a parking guidance apparatus according to an embodiment of the present invention. The parking guidance apparatus includes a position unit 110 and a vehicle guidance unit 120, wherein the position unit 110 is disposed on a position point outside of a vehicle and provides a position signal PS. Taking an application of the parking guidance as an example, the position point may be a position the vehicle should be parked at, typically at a parking position. The vehicle guidance unit 120 is disposed in the vehicle with a function for sensing the position signal PS and displaying a guidance message GM according to the power strength and direction of the position signal PS. The guidance message GM contains the corresponding position relationship between the vehicle and the position point.

In another embodiment, the vehicle guidance apparatus 120 includes at least a sensing module 122, a signal process unit 124, a display unit 126, and a guidance transmit unit 128. The signal process unit 124 further includes a control unit 130 and a computation unit 132, wherein the control unit 130 is coupled between the sensing module 122 and the display unit 126. The number of the sensing modules 122 may be adjusted as desired. The computation unit 132 and the guidance transmit unit 128 are coupled to the control unit 130 respectively. The position unit 110 includes a receive unit 112 and a transmit unit 114 which are coupled to each other.

When the parking guidance apparatus starts to operate, under the control of the control unit 130, the guidance transmit unit 128 provides a guidance start signal GS to the receive unit 112. The transmit unit 114 determines whether to send out a position signal PS or not according to whether the receive unit 112 receives the guidance start signal GS or not. The position signal PS in the embodiment can be an infrared signal or a radar wave signal. The sensing module 122 outputs a position identification signal PIS to the control unit 130 according to the sensed power strength and direction of the position signal PS. The control unit 130 transmits the position identification signal PIS to the computation unit 132, and a corresponding position relationship between the vehicle and the position point is obtained after computation. The computation unit 132 outputs a computation signal CS to the control unit 130 according to the corresponding position relationship. The control unit 130 outputs the guidance message GM to the display unit 126 according to the computation signal CS.

In another embodiment, the parking guidance apparatus can identify the corresponding position relationship between the vehicle and the position point with a simple architecture, that is, the position unit 110 can provide a position signal PS without receiving a guidance start signal GS, while the vehicle guidance unit 120 directly outputs a guidance message GM through sensing the power strength and direction of the position signal PS. In other words, the parking guidance apparatus can identify the corresponding position relationship between the vehicle and the position point without the guidance transmit unit 128 and the receive unit 112.

In another embodiment, the control unit 130 can also obtain the corresponding position relationship between the vehicle and the position point through a look-up table and output a guidance message GM according to the comparison result. Data of the relationship between the changes of the position identification signal PIS and the corresponding position are stored in the look-up table.

The guidance message GM indicates the corresponding position relationship between the vehicle and the position point. The display unit 140 displays the message indicated by the guidance message GM in the way of at least one of text, graphic, indicator, and sound.

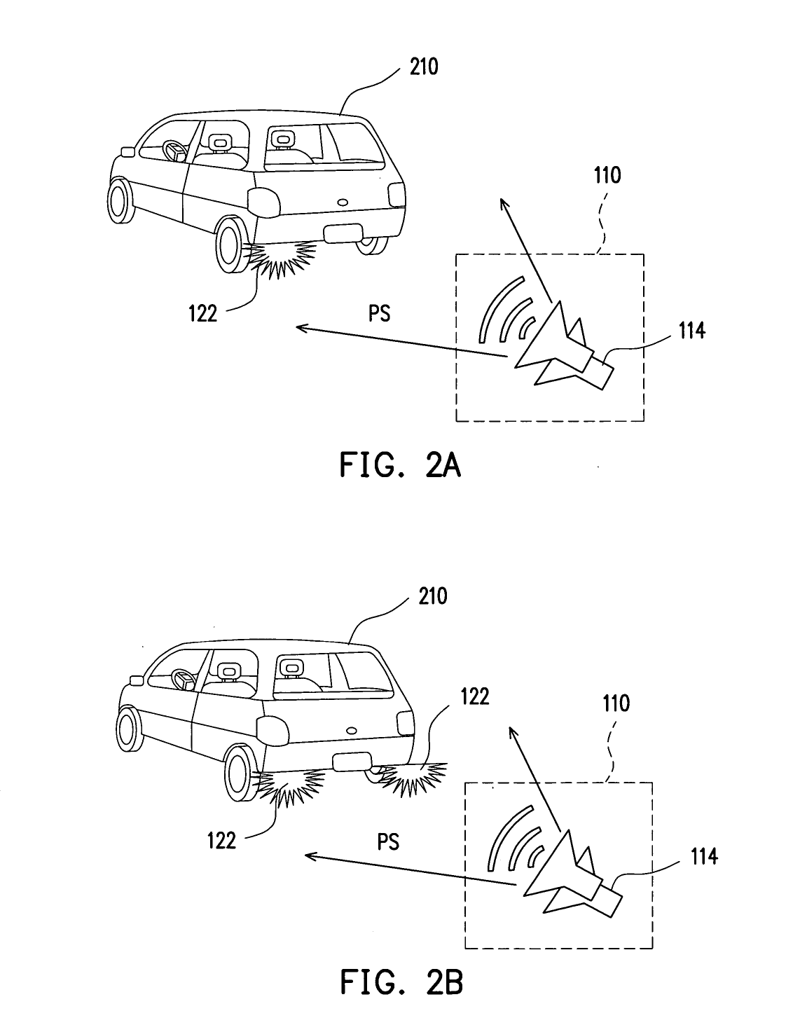

Then, the application of the present invention in the parking guidance apparatus will be illustrated in the embodiments. FIG. 2A is a view of a single-positioning parking guidance apparatus according to another embodiment of the present invention. As shown in FIG. 2A, only one sensing module 122 is disposed in a vehicle 210, and the position unit 110 located at a position point outside the vehicle 210 only has a transmit unit 114. This embodiment is a simple embodiment. The transmit unit 114 sends a position signal PS. The vehicle guidance unit 120 in the vehicle 210 senses the position signal PS by using the sensing module 122, calculates the corresponding position relationship between the vehicle 210 and the position point according to the direction and power strength of the position signal PS, and outputs the guidance message GM. And the guidance message GM is displayed in the way of at least one of text, graphic, indicator, and sound.

In order to illustrate the embodiments of the present invention more clearly, the following embodiments are illustrated with reference to the numerals shown in FIG. 1.

FIG. 2B is a view of a single-transmitting parking guidance apparatus according to another embodiment of the present invention. The vehicle guidance unit 120 in the vehicle 210 includes two sensing modules 122, and the position unit 110 located at a position point outside of the vehicle 210 also includes a transmit unit 114 and sends out the position signal PS. The vehicle guidance unit 120 carries out a cross comparison with two sensing units 122, thus improving the accuracy of the corresponding position relationship between the vehicle 210 and the position unit 110. As the transmission of the position signal PS is tender to be influenced by the variation of the external environment, the accuracy of the corresponding position relationship between the vehicle 210 and the position point 110 can be improved by using multiple sensing modules 122 and a mathematical computation. After the vehicle guidance unit 120 has identified the corresponding position relationship between the vehicle 210 and the position unit 110, the guidance message GM is displayed in the way of at least one of text, graphic, indicator, and sound.

FIG. 2C is a view of a multi-transmitting parking guidance apparatus according to another embodiment of the present invention. In this embodiment, the vehicle guidance unit 120 in the vehicle 210 includes two sensing modules 122 and a guidance transmit unit 128, and the position unit 110 of a position point outside the vehicle 210 includes a receive unit 112 and a transmit unit 114. When the guidance transmit unit 128 sends the guidance start signal GS to the receive unit 112, the position unit 110 makes the transmit unit 114 send out the position signal PS according to the guidance start signal GS. The vehicle guidance unit 120 senses the power strength and direction of the position signal PS by using the two sensing modules 122 and confirms the corresponding position relationship between the vehicle 210 and the position point through a cross comparison. The display unit 126 displays the corresponding position relationship thereof, thus assisting the driver to park the vehicle 210 at the position point.

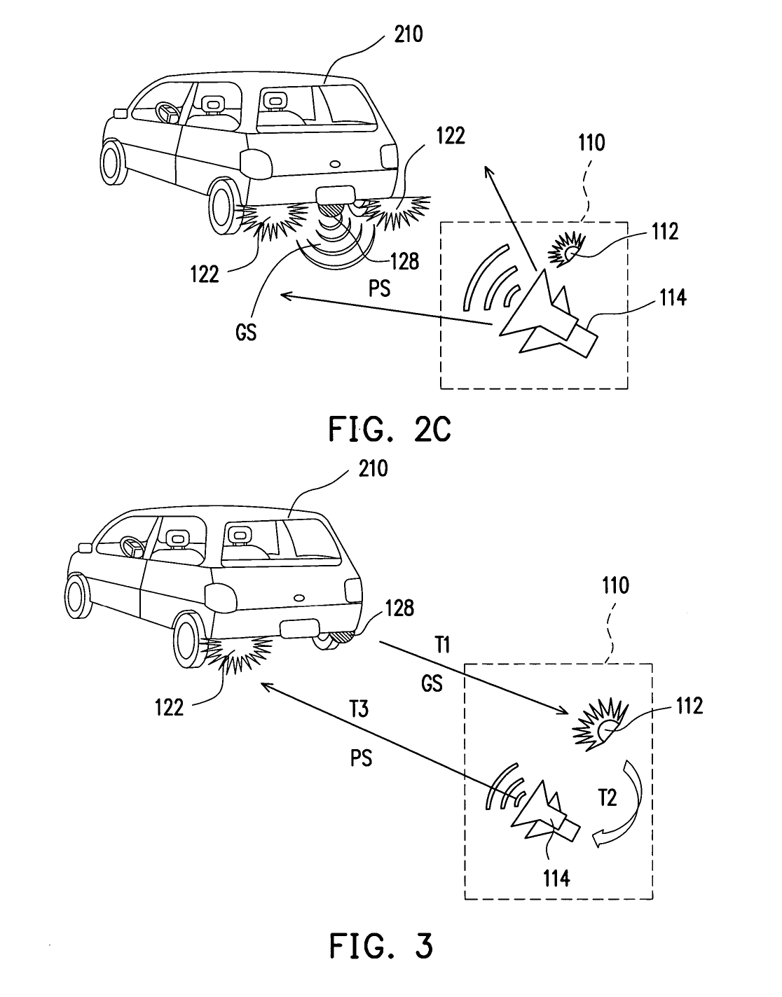

Moreover, in this embodiment, the corresponding distance relationship between the vehicle 210 and the position point can be deduced by using the corresponding relationship between the signal transmitting time and distance. FIG. 3 is a view showing the relationship between the signal transmitting time and distance of the parking guidance apparatus according to this embodiment. As shown in FIG. 3, the position unit 110 is located at a position point outside of a vehicle 210. The time required by the vehicle guidance unit 120 in the vehicle 210 to send the guidance start signal GS with the guidance transmit unit 128 to the receive unit 112 in the position unit 110 is assumed to be a time length T1. The circuit action time of the position unit 110 from the receive unit 112 receiving the guidance start signal GS to the transmit unit 114 emitting the position signal PS is assumed to be a time length T2. And the time for transmitting the position signal PS to the sensing module 122 by the transmit unit 114 is assumed to be a time length T3. The corresponding distance relationship between the vehicle 210 and the position point can be converted by using the relationship between the signal transmitting speed and time. The relative distance relationship between the vehicle 210 and the position point directly calculated according to the sensing results of the sensing module 122 can be verified.

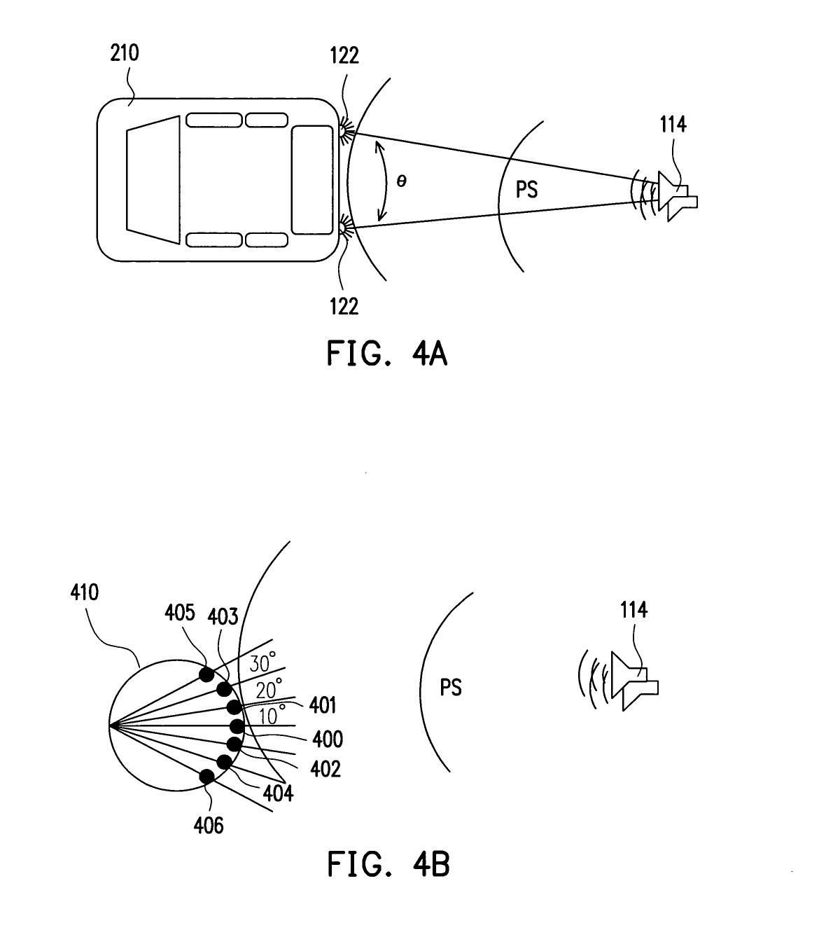

Then, the method for the vehicle guidance apparatus to identify the corresponding position relationship between the vehicle 210 and the position point is further illustrated. FIG. 4A is a schematic view of a sensing manner of multiple sensing modules according to an embodiment of the present invention. When the transmit unit 114 sends out a position signal PS, two sensing modules 122 in the vehicle sense the power strength and direction of the position signal PS respectively. An angle θ is generated by using two sensing modules 122 to sense the direction of the position signal PS, and the signal process unit 124 can calculate the corresponding position relationship between the vehicle 210 and the position point through a mathematic computation, such as a trigonometric function, according to the variation of the angle θ, thereby further improving the accuracy of the guidance message GM.

FIG. 4B is a view showing a structure and sensing action of the sensing module according to an embodiment of the present invention. The sensing module 410 includes multiple sensors 400˜407, wherein the sensors 400˜407 are arranged in a circular arch with the sensor 400 as a datum point. When the transmit unit 114 sends out the position signal PS, as the sensors 400˜407 are arranged in different positions, the power strength of the position signal PS sensed by the sensors 400˜407 is also different. The signal process unit 124 compares the position identification signals PIS generated by the sensors 400˜407, and selects a sensor (e.g. the sensor 401) having a largest sensing value, indicating that the direction of the sensor 401 is the direction closest to the transmit unit 114 (such as compared with the datum point of the sensor 400, the angle deviates 10°). The distance between the vehicle 210 and the position point can be converted by the power strength of the position signal PS sensed by the sensor 401. The corresponding position relationship between the vehicle 210 and the position point can be calculated through a comparison of selecting a largest sensing value.

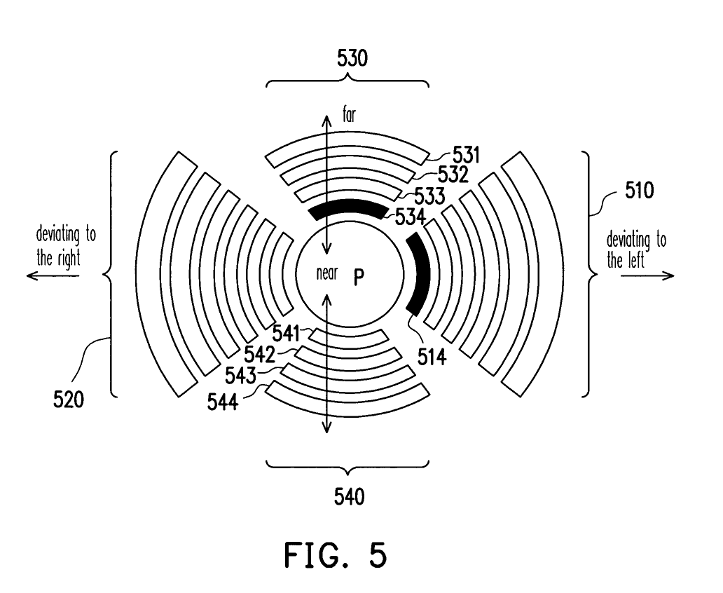

After the corresponding position relationship between the vehicle 210 and the position point is calculated, the display unit 126 displays the corresponding position relationship between the vehicle 210 and the position point. FIG. 5 is a view of display indicators of the parking guidance apparatus according to another embodiment of the present invention. As shown in FIG. 5, the corresponding position relationship between the vehicle 210 and the position point is indicated by different actions of indicator (e.g. lightup or glitter). A central indicator P indicates the position of the position point. A top indicator 530 and a bottom indicator 540 include four small indicators 531˜534 and 541˜544 respectively. The top indicator indicates the distance of the vehicle 210 exceeding the position point, while the bottom indicator indicates the distance of the vehicle 210 to the position point (such as if the indicator 534 is in action, it indicates that the vehicle 210 has exceeded the position point). The farther from the center indicator P, the larger distance between the vehicle 210 and the position point. For example, if the outmost indicator is in action, it indicates that the distance between the vehicle 210 and the position point (such as the indicator 531 or 541) is largest. A right indicator 510 includes 6 small indicators, indicating the degree of the vehicle 210 deviating to the left. The outer indicator indicates the larger deviation of the vehicle 210 to the left, and also indicates the extent to adjust the steering wheel of the vehicle 210 (e.g. if the indicator 514 is in action, it indicates that the steering wheel should be turned a half circle to the right). Otherwise, if the vehicle 210 deviates to the right, six small indicators included in the indicator 520 take an action according to the degree of the right deviation of the vehicle 210. Of course, the indicator action manner depends on the requirements of the driver, and is not limited to this embodiment.

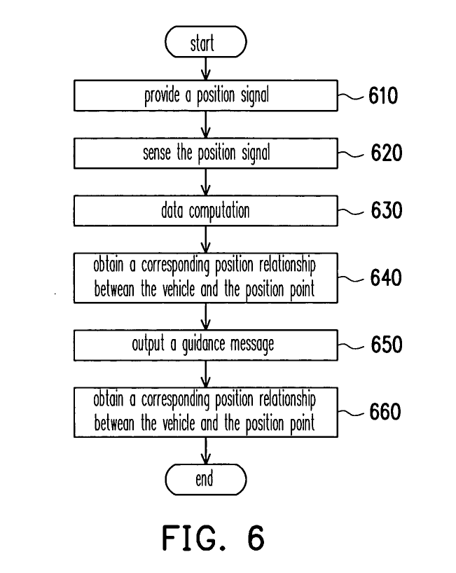

From another point of view, the present invention provides a parking guidance method. FIG. 6 is a flow chart of a parking guidance method according to another embodiment of the present invention. When the driver activates the parking guidance apparatus (e.g. shifting into a reverse gear), the flow chart of the parking guidance method begins. In Step 610, the position unit 110 provides a position signal PS according to the guidance start signal GS. In Step 620, the vehicle guidance unit 120 senses the power strength and direction of the position signal PS by using the sensing module 122 and outputs a position identification signal PIS. In Step 630, the signal process unit 124 carries out a data computation according to the position identification signal PIS. In Step 640, the corresponding position relationship between the vehicle 210 and the position point is obtained, and a computation signal CS is output. In Step 650, the signal process unit 124 outputs a guidance message GM according to the computation signal CS, wherein the guidance message contains the corresponding position relationship between the vehicle 210 and the position point. Finally, in Step 660, the display unit 126 displays the corresponding position relationship between the vehicle 210 and the position point contained in the guidance message GM.

To sum up the above embodiments, the present invention provides a position signal at a position point outside of the vehicle, such that the vehicle guidance unit may enable the driver easily to acquire the corresponding position relationship between the vehicle and the position point and assist the driver to determine the vehicle advancing direction and the vehicle parking operation, by sensing the power variation and direction of the position signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A parking guidance apparatus for guiding a vehicle, comprising:
a position unit, disposed at a position point outside of the vehicle and providing a position signal; and
a vehicle guidance unit, disposed in the vehicle for sensing power strength and direction of the position signal and displaying a guidance message according to the power strength and direction of the position signal;
wherein, the guidance message contains a corresponding position relationship between the vehicle and the position point.

2. The parking guidance apparatus as claimed in claim 1, wherein the position unit comprises a transmit unit for providing the position signal.

3. The parking guidance apparatus as claimed in claim 1, wherein the position signal comprises an infrared signal.

4. The parking guidance apparatus as claimed in claim 1, wherein the position signal comprises a radar wave.

5. The parking guidance apparatus as claimed in claim 1, wherein the vehicle guidance unit comprises:
at least one sensing module, for sensing the position signal and outputting an identification signal according to the strength and direction of the position signal;
a signal process unit, coupled to the sensing module, for outputting a guidance message according to the identification signal; and
a display unit, coupled to the signal process unit for displaying the guidance message;
wherein, the sensing module has multiple sensors arranged in a circular arch and identifies the power strength and direction of the position signal by using the difference of arrangement and direction thereof.

6. The vehicle guidance apparatus as claimed in claim 5, wherein the signal process unit comprises a control unit coupled between the sensing module and the display unit, for outputting the guidance message according to the identification signal.

7. The vehicle guidance apparatus as claimed in claim 6, wherein the signal process unit further comprises:
a computation unit, coupled to the control unit, for computing the corresponding position relationship between the vehicle and the position point according to the identification signal, and outputting a computation result;
wherein the control unit outputs the guidance message according to the computation result.

8. The vehicle positioning apparatus as claimed in claim 6, wherein the signal process unit further comprises:
a look-up table;
wherein the control unit compares the corresponding position relationship between the vehicle and the position point according to the identification signal and the look-up table to output the guidance message.

9. The parking guidance apparatus as claimed in claim 5, wherein the display unit displays the guidance message comprising at least one of text, graphic, indicator, and sound.

10. The parking guidance apparatus as claimed in claim 1, wherein the vehicle guidance unit further comprises a guidance transmission unit, for providing a guidance start signal.

11. The parking guidance apparatus as claimed in claim 10, wherein the position unit comprises a receive unit for receiving the guidance start signal, and provides the position signal according to the guidance start signal.

12. A parking guidance method, comprising:
providing a position signal at a position point outside of a vehicle;
sensing the position signal in the vehicle; and
displaying a guidance message in the vehicle according to the power strength and direction of the position signal;
wherein the guidance message comprises the corresponding position relationship between the vehicle and the position point.

13. The parking guidance method as claimed in claim 12, further comprising:
providing a guidance start signal in the vehicle; and
providing the position signal at the position point according to the guidance start signal.

14. The parking guidance method as claimed in claim 12, wherein the position signal comprises an infrared signal.

15. The parking guidance method as claimed in claim 12, wherein the position signal comprises a radar wave.

16. The parking guidance method as claimed in claim 12, wherein the steps of displaying the guidance message comprise:
generating an identification signal in the vehicle according to the sensed power strength and direction of the position signal;
outputting the guidance message according to the identification signal; and
displaying the guidance message in the way of at least one of text, graphic and indicator.

17. The vehicle guidance method as claimed in claim 16, wherein the step of outputting the guidance message according to the identification signal comprises:
comparing the corresponding position relationship between the vehicle and the position point and outputting the guidance message according to the identification signal and a look-up table.

18. The vehicle guidance method claimed in claim 12, wherein the way to display the guidance message comprises at least one of text, graphic, and indicator.

19. The vehicle guidance method claimed in claim 12, further comprising shifting into a reverse gear.
